(19) United States
(12) Patent Application Publication
(10) Pub. No.: US 2005/0184421 A1
(43) Pub. Date: Aug. 25, 2005

(54) Dynamically forced wetting of materials and products produced therefrom

(76) Inventor: Ernest Nagy de Nagybaczon, Hove (GB)

Correspondence Address: MARK G. MORTENSON, POST OFFICE BOX 310, NORTH EAST, MD, 21901-0310, US

(21) Appl. No.: 10/621,786

(22) Filed: Jul. 17, 2003

Related U.S. Application Data
(63) Continuation-in-part of application No. PCT/IB02/01813, filed on Jan. 18, 2002.
(60) Provisional application No. 60/396,956, filed on Jul. 18, 2002.

(51) Int. Cl. C04B 33/32

(52) U.S. Cl. 264/68; 264/640; 264/642; 264/645; 264/649; 264/669

(57) ABSTRACT

The present invention relates to a novel group of related processes referred to generally as the dynamically forced wetting of materials. This novel group of processes has been used, for example, to form composite bodies. However, the present invention focuses on certain novel characteristics of the dynamically forced wetting of materials to produce useful materials in a new and unexpected manner. The products produced according to the present invention are, typically, formed under the application of pressure, which is applied to a particular combination of materials which are arranged in a specific manner. In the most preferred embodiments of the present invention, relatively high pressures are developed by suitable constriction means which either naturally occur during infiltration and/or are provided separately. The constriction means are provided to assist in achieving the required conditions which result is the dynamically forced wetting of materials. The combination of relatively high pressures and relatively short infiltration times (and sometimes with relatively rapid quenching or cooling) results in a variety of novel products according to the present invention.

### BENEFIT CLAIM TO PRIOR APPLICATIONS

This Application claims the benefit of U.S. Provisional Application No. 60/396,956, filed Jul. 18, 2002, and entitled, “Dynamically Forced Wetting of Materials and Products Produced Therefrom”.

This Application is also a Continuation-In-Part of International Application No. PCT/IB02/01813 having an international filing date of Jan. 18; 2002, and entitled “Dynamically Forced Wetting of Materials and Products Produced Therefrom”.

### FIELD OF THE INVENTION

The present invention relates to a novel group of related processes referred to generally as the dynamically forced wetting of materials. This novel group of processes has been used, for example, to form composite bodies. However, the present invention focuses on certain novel characteristics of the dynamically forced wetting of materials to produce useful materials in a new and unexpected manner. The products produced according to the present invention are, typically, formed under the application of pressure, which is applied to a particular combination of materials which are arranged in a specific manner. In the most preferred embodiments of the present invention, relatively high pressures are developed by suitable constriction means which either naturally occur during infiltration and/or are provided separately. The constriction means are provided to assist in achieving the required conditions which result is the dynamically forced wetting of materials. The combination of relatively high pressures and relatively short infiltration times (and sometimes with relatively rapid quenching or cooling) results in a variety of novel products according to the present invention.

### BACKGROUND OF THE INVENTION

The present invention has traceable roots to the formation of composite materials. Composite materials are typically defined as any material composed of at least two types of distinguishable materials. The materials can differ from each other in physical form and/or composition. Typically, composite materials have been of interest in a variety of different fields due to the ability to add a strengthening or reinforcing phase, such as a fiber, particulate, whisker or the like, into a matrix which synergistically combines with such filler material.

There are many well-known and different techniques that have historically been utilized to form composite bodies. These techniques include generally: both pressure (e.g., typically low pressures and/or slow infiltration) and pressureless infiltration of a matrix material into a filler material; conventional mixing or milling approaches followed by, for example, shaping by use of; various molding or shaping techniques, as well as a variety of more exotic techniques.

The dynamically forced wetting of materials approach to forming composite materials provides a simple, reliable group of processes to result in a wide variation of desirable composite products of virtually any desired shape, or of no particular shape. These composite products are capable of being manufactured so as to have a wide spectrum of desirable mechanical properties.

However, by combining certain novel aspects of the dynamically forced wetting of materials with a particular combination of starting materials (e.g., particular composition(s), size(s) and/or shape(s) of starting materials) very significant commercial materials can be manufactured in a new and unexpected manner (e.g., useful materials can be harvested from at least a portion of a formed composite).

### DEFINITIONS

As used herein in the Specification and the appended claims, the terms below are defined as follows:

“Barrier” or “Barrier Means”, as used herein, means any suitable means which interferes, inhibits, prevents or terminates the migration, movement, or the like of one or all of the constituents of a forming and/or formed composite material beyond a desired surface boundary, where such surface boundary is defined by said barrier means. Suitable barrier means may be any such material, compound, element, composition, or the like, which under the process conditions of the invention maintains some integrity and is not substantially volatile with any of the elements in the system and/or the process. The barrier reduces any final machining or grinding that may be required and defines at least a portion of the surface of the resulting composite product. The barrier may in certain cases be porous, or rendered permeable by, for example, drilling holes or puncturing the barrier.

“Binder or Matrix Material”, as used sometimes interchangeably herein, means any material that is an essentially pure material (e.g., a relatively pure, commercially available unalloyed material) or other grades of materials which are alloys and/or any material which contains impurities and which may comprise two or more completely different materials. A binder or matrix material is typically in a liquid or liquid-like state contiguous with the binder or matrix material contacting the filler material or preform just prior to infiltration thereof. A binder can include virtually any material capable of, for example, cold flow and subsequent liquefaction as the binder is forced through one or more orifices or orifice-like conditions (e.g., constriction means) which may occur naturally in a filler material or preform, or within, or contiguous to, a mold for containing the filler material or preform which has been specifically modified to serve as a constrictive means (e.g., either alone or in combination with the naturally occurring constriction means); and when in a liquid state, but subsequent to being combined with a filler material or preform, can develop, if desired, solid or solid-like characteristics between at least portions of the filler material which can cause or permit filler material(s) to become rigidly bonded to at least their immediate neighbors. In some cases, it may be desirable for the binder to be substantially non-hardenable so that a resultant composite product may be spongy, flexible and/or compliant. Binders may include: water, when used in combination with fibers that require water to initiate one or more chemical reaction(s) (e.g., when water dissolves or partially dissolves at least a portion of a surface of the fiber in order to create a bond and/or when fibers rely on hydrogen for bonding to each other); any resin, natural or synthetic, organic or inorganic; any mineral or metal capable of liquefaction and subsequent solidification under the process conditions of the invention; and/or any solvent capable of dissolving at least a portion of at least one surface of at least one filler material in order to create a bond therebetween. Typically, the term “binder” is used herein when a small amount (i.e., relative to the amount of surface area of a filler material) of material is used to form a composite product; whereas the term “matrix material” is utilized herein when a greater amount (i.e., relative to the amount of surface area of a filler material) of material is used to form a composite product. Typically, when the term “matrix” is utilized herein, the term refers to an at least partially to substantially completely, three-dimensionally interconnected material that has at least partially infiltrated a filler material. The properties of the composite material formed may be a function of the amount of binder or matrix material present relative to the surface of the filler material as well as whether or not the binder or matrix material is three-dimensionally interconnected after at least partial infiltration of the material.

“Filler” or “filler material”, as used sometimes interchangeably herein, is intended to include either single constituents or mixtures of constituents which can be at least partially reactive (and in some cases substantially completely reactive) with one or more other constituents in the composite material or product, or, alternatively, are substantially non-reactive with and/or are of limited solubility with some or all other constituents in the composite material or product. Fillers may be single or multi-phase. Fillers may be naturally occurring or manmade materials. Fillers may be provided in a wide variety of forms and sizes such as powders, flakes, platelets, microspheres, whiskers, bubbles, etc. For example, fillers may include any substantially asicular, tape or coil-shaped material of any length or any complex network of such fibers; any substantially spherical (which may be dendritic or thromboidal) material or any complex network of such entities; any platelet-like material or any complex network of such entities; any ordered network of fibers (e.g., tows of fibers or yarn such as cotton); any random or ordered network of fibers, filaments, yarns or tows as in felted, knitted, woven and/or non-woven fabrics; and/or any other particulate material.

“Infiltration Atmosphere”, as used herein, means that atmosphere which is present which interacts with the matrix material or binder and/or preform (or filler material) and/or permits or enhances wetting of at least one material in the composite to at least one other material in the composite.

“Macrocomposite”, as used herein, means any combination of two or more materials selected from the group consisting of polymer, polymer matrix composite, metal, metal matrix composites, ceramics and ceramic matrix composites, which are intimately bonded together in any configuration, wherein at least one of the materials bonded to at least one member of said group comprises at least one composite material or product made according to one or more dynamically forced wetting of materials processes of the present invention.

“Preform”, as used herein, means a porous mass of filler or filler material which is manufactured with at least one surface boundary which essentially assists in defining a boundary for the infiltration of binder(s) or matrix material(s). The mass should be sufficiently porous to accommodate infiltration of the binder(s) or matrix material(s) into the preform. A preform typically comprises a bonded array or arrangement of filler(s), either homogenous or heterogeneous, and may be comprised of any suitable material(s) (e.g., ceramic and/or metal particles, powders, fibers, whiskers, etc., and any combination thereof). A preform may exist either singly or as an assemblage.

### BRIEF DESCRIPTION OF THE FIGURES

The following Figures are provided to assist in understanding the invention, but are not intended to limit the scope of the invention. Similar reference numerals have been used wherever possible in each of the Figures to denote like components, wherein:

FIG. 1a is a cross-sectional schematic view of a simple lay-up used to fabricate a composite, according to the process referred to as the dynamically forced wetting of materials, just prior to the application of pressure; and FIG. 1b is a cross-sectional schematic view of FIG. 1a after substantially complete compression of the simple lay-up.

FIGS. 2a and 2b are perspective views of two (2) presses capable of being utilized to form composite products by a batch process according to the dynamically forced wetting of materials.

FIG. 3 is a cross-sectional schematic view of a lay-up for forming a complex-shaped composite product by a batch process according to the process referred to as the dynamically forced wetting of materials.

FIG. 4a is a cross-sectional schematic view of a partially infiltrated filler material being formed by a batch formation process according to the dynamically forced wetting of materials; and FIG. 4b is a cross-sectional schematic view of a fully infiltrated filler material formed by a batch process according to the dynamically forced wetting of materials.

FIG. 5 is a perspective view of the top of one apparatus used to fabricate composite products substantially continuously according to the process referred to as the dynamically forced wetting of materials.

FIG. 6a is a cross-sectional schematic view of how the composite formation process occurs in the apparatus shown in FIG. 5; FIG. 6b is a cross-sectional view taken along the line B-B′ in FIG. 6a; and FIG. 6c is a cross-sectional view taken along the line A-A′ in FIG. 6a.

FIG. 7 is a cross-sectional schematic view of a simple lay-up used to fabricate diamonds according to the present invention.

FIG. 7a is a perspective view of a constriction means used in FIG. 7.

FIG. 8 is a perspective view of a typical press which can be utilized to form products from the lay-up shown in FIG. 7.

### SUMMARY OF THE INVENTION

The present invention has been developed to manufacture useful industrial materials by a novel combination of techniques and materials which techniques are efficient, reliable, simple and economical.

It is a primary object of the present invention to provide a method for achieving the dynamically forced wetting of filler(s) (e.g., by using a batch, semi-continuous and/or continuous approach) which is a simple, quick, cost effective and reliable and which result in commercially significant materials such as diamond, cubic boron nitride and other hard complex crystalline materials, etc.

Another object of the present invention is to combine certain binder(s) or matrix material(s) with certain filler material(s) that are typically, under prior art approaches, not capable of being wetted by said binder or matrix materials, but, by utilizing the disclosed dynamically forced wetting processes of the disclosed invention, are capable of being wetted.

It is a further object of the present invention to produce products with desirable properties (e.g., mechanical, acoustic, electric, ballistic, etc.) by: (1) utilizing a variety of filler material(s) which may typically not be utilized in traditional composite manufacturing approaches (e.g., the filler material(s) include both naturally occurring and manmade materials); and/or (2) causing the binder or matrix material(s) to adopt or form a harvestable material or microstructure within at least a portion of the filler material(s) and/or on or adjacent to at least a portion of the filler material, said harvestable material being capable of being removed from the formed composite by conventional techniques.

It is another object of the present invention to produce composite products having non-homogenous or graded properties, wherein a harvestable portion of the non-homogenous composite product is itself somewhat homogenous and is capable of being separated or harvested from other remaining portions of the composite product. The harvestable portion can be removed by somewhat conventional techniques such as etching, leaching, sand blasting, physical separation, etc.

It is another object of the present invention to produce macrocomposite bodies, wherein at least a portion of one of the bodies comprising the macrocomposite is a manufactured according to one or more of the dynamically forced wetting processes described herein and, wherein a portion of the non-homogenous composite product is itself somewhat homogenous and is capable of being separated or harvested from other remaining portion so of the composite product, said harvesting occurring by the techniques mentioned above.

To achieve all of the foregoing objects and advantages, and to overcome the disadvantages of prior art manufacturing techniques and certain prior art composite products per se, the present invention utilizes a number of novel processing approaches referred to generally as the dynamically forced wetting of filler material(s). In general, the dynamically forced wetting of material(s) refers to the forced infiltration or penetration of a liquid (or a material that can be made to have liquid-like properties) at least partially into, and/or substantially completely through, at least one filler material. In particular, the infiltration or penetration of a liquid results in the generation of at least some heat (e.g., internally within the system) due to the following factors: (1) the amount of force or pressure applied to the liquid; (2) the distance traveled by the liquid as the liquid contacts the filler material (e.g., the smaller the surface area of the individual filler material, and consequently the greater the total surface area of the filler that the liquid comes in contact with, the greater the distance the liquid travels from one side of a mold to the other side of a mold); (3) the amount of time given for the liquid to contact the filler material (e.g., the amount of time allowed for complete infiltration to occur); and/or (4) the amount of constriction resulting naturally occurring within the filler material and/or added externally in, for example, at least a portion of the mold (a molding apparatus) which contains the filler material. The specifics of dynamically forced wetting of materials is discussed later herein.

First, an appropriate filler material or filler materials need to be selected. It should be understood that some or all of the filler materials may or may not survive the processing conditions of the invention and thus may or may not be distinguishable in some or all of the products formed according to the present invention. Due to the processing conditions of the invention, an unusually large selection of customary, as well as substantially “non-traditional”, filler materials can be used with the dynamically forced wetting processes of the present invention. However, the chemical composition of the filler may be important to achieve desirable products in or on at least a portion of a body formed by the processes referred to as the dynamically forced wetting of materials. In general, filler materials of virtually any size (e.g., a few microns in size up to a few centimeters in size) can be utilized depending on what processing conditions are desirable to achieve.

With regard to non-conventional fillers, the process referred to as the dynamically forced wetting of materials can utilize fillers which are not traditionally thought of as being possible candidates in, for example, structural applications. Non-conventional fillers, both naturally occurring and manmade, such as feathers, yarn of all types, fiber of all types, fabric of all types, sawdust, foliage, kitin (e.g., shellfish shells), sisal, hemp, hay, ricestraw, sand, wool, steel wool, wood chips, waste products from manufacturing operations dust from the floor, contaminated earth, etc., are all capable of being made into composite products by the dynamically forced wetting techniques of the disclosed invention. Thus, filler materials can be selected to be used with the process referred to as the dynamically forced wetting of materials without much consideration for whether such filler materials can be compatible with the processes of the present invention. This permits enormous flexibility in manufacturing design of the chosen filler materials which provide the other necessary elements (e.g., composition, size, shape, etc.) which are desirable to achieve useful products from producing the process referred to as the dynamically forced wetting of materials. One or more of these traditional or non-conventional fillers may be loosely arranged or contained within a suitable barrier (e.g., a mold or tool) and/or one or more of such fillers may be pre-shaped or pre-arranged as a preform and positioned within a suitable mold or tool. Moreover, it is possible for the shaped filler or preform to have a coating on at least one surface thereof which may permit the coated preform to behave essentially like a mold.

Combinations of such coatings, along with traditional mold materials or tools (e.g., metal tools), may be desirable in manufacturing certain products. However, in some cases, a traditional metal mold or tool may be all that is required to form a desirable end product (e.g., forming a desirable product in an or on at least a portion of a composite material formed according to the present invention).

Still further, it is possible that the filler or preform may be positioned within or adjacent to one or more materials which themselves may be a composite, and which can be made to function substantially as a barrier or mold, but may also permit the filler material or preform, when infiltrated with a binder or matrix, to be bonded directly to such material, if desired, thereby forming a macrocomposite body. For example, it is possible to design many material system's wherein at least one material utilized in the formation of the composite body is capable of bonding to at least a portion of a material placed adjacent to an infiltrated filler material or preform (e.g., so long as at least a portion of a filler and/or at least a portion of a binder or matrix is capable of being bonded to said adjacently-placed material).

After selecting an appropriate filler material, an appropriate binder or matrix material needs to be selected. One important criterion in the selection of the binder or matrix material is that at, or immediately preceding the application of a pressure (i.e., a pressure used to cause the dynamically forced wetting of the filler material forces the binder or matrix material into the filler material in a relatively short amount of time), that the binder is in a liquid state. Thus, any material that is capable of, for example, cold flow and subsequent liquefaction as the binder is forced through one or more orifices, constrictive means (e.g., either naturally occurring within at least a portion of the lay-up or specifically added as a part of the molding or shaping apparatus), or orifice-like conditions which may occur or be present in or contiguous to a mold (e.g., a gate leading into a mold) and/or can result in a filler material or preform per se (i.e., the liquid is, or can be made to be a liquid, at least just at the time of infiltrating the filler material per se), under a set of process conditions that cause the filler material to behave as envisioned can qualify as an acceptable binder or matrix material.

However, another important criterion in the selection of the binder or matrix material is how the binder or matrix material behaves subsequent to the binder or matrix material being combined with a filler material or preform. For example, in a first instance, the binder should be capable of developing solid or solid-like characteristics between at least some portions of (or substantially all of) the filler material which can cause or permit such filler materials to become rigidly bonded to at least their immediate neighbors. These important features of one aspect of the invention are discussed in greater detail elsewhere herein.

Additionally, depending on the amount of matrix material utilized relative to the surface area of the filler material, the matrix material per se may be substantially three dimensionally interconnected throughout some or all of the resultant composite body. Still further, by practicing a simple variation of the processes described herein, another family of unique composites can be manufactured. In this approach, a composite can be manufactured such that a portion of it (e.g., a portion at or near a center portion of the composite) does not have any significant amount of binder or matrix material present then the specifics of this process and the materials which result therefrom are discussed later herein. Thus, approaches may assist in the ultimate goal of harvesting at least a portion of the formed composite as a substantially homogenous material.

Accordingly, due to the variety of processing choices and the novel and flexible nature of the dynamically forced wetting processing techniques of the described invention, a wide variety of binders or matrix materials can be processed in accordance with the processing conditions of the invention, all of which may result in a wide variety of desirable composite bodies heretofore unknown in the art. For example, certain filler materials are capable of appropriately interacting (e.g., surviving or reacting), the processing conditions of the dynamically forced wetting techniques of the present invention, which permits virtually any combination of acceptable binder/matrix material/filler material/preform combinations can be utilized to achieve the goals of the present invention which include forming one or more desirable materials in or on at least a portion of the formed composite and subsequently harvesting the desirable materials for alternative uses. The harvesting approaches suitable for use with the present invention include somewhat conventional techniques including, but not limited to, chemical etching, leaching, physical or mechanical separation techniques, sand blasting, etc. Further, if the binder or matrix material does not reach liquefaction until temperatures substantially above room temperature (e.g., about 150° C.) then, consideration should be given to the mold materials utilized; the high-temperature capability of all portions of apparatuses utilized to form the composite which may be subject to high temperatures, etc. (i.e., the complete manufacturing apparatus may need to be able to survive the composite formation processing conditions).

The present invention permits the amount (e.g., volume percent or weight percent) of binder or matrix material that is used in combination with the filler material to be relatively small (e.g., typically referred to herein as a “binder”) relative to the amount (i.e., surface area) of filler present; or the amount of binder or matrix material can be relatively large (e.g., typically referred to herein as “matrix material”) relative to the amount (i.e., surface area) of filler present. When a small amount of such binder and/or matrix material is utilized, then at least a portion of the material may essentially function as a binder which binds or “glues” together various parts of filler material where such filler material contacts or intersects with other filler material. In such cases, the resultant composite product may have properties that are substantially dominated by the filler material (i.e., the filler material is the only material which may be three-dimensionally interconnected throughout the formed composite) and the material of interest that is to be harvested from the formed composite may be located at portions throughout the filler material. However, when a larger amount of such material is utilized, then properties more characteristic of each of the materials comprising the resultant composite product are likely to dominate. For example, each of the filler material and matrix material may be three-dimensionally interconnected; or the matrix material may be three dimensionally interconnected and the filler material may be embedded by the matrix material and not be connected three-dimensionally in any significant amount. The material of interest which is to be harvested from the formed composite may be located at various positions or locations within and/or on the formed composite. Moreover, as discussed in greater detail elsewhere herein, the nature of the predominant crystalline phase(s) present in the binder may be advantageously altered from a state that would ordinarily be expected to be present, into an unexpected crystalline (or amorphous) state is possible to achieve due to the novel dynamically forced wetting techniques of the disclosed invention. This aspect of the invention can result in the production of very useful harvestable material(s) in at least a portion of a formed composite.

Moreover, filler materials can be arranged, prior to infiltration, either randomly or in a pre-determined and pre-selected manner. Alternatively, combinations of randomly oriented and specifically oriented fillers can be placed within a mold or formed into a preform to achieve non-homogenous properties in a composite body which may assist in forming the composite body and/or the material which is to be harvested from the composite. For example, it may be desirable for a portion of the composite to be stronger than another portion of the composite. Additionally, fillers could be positioned both within and outside of a mold to permit external communication with an external filler. The present invention permits virtually limitless combinations of materials to be designed for almost any application. Still further, fillers can be positioned within a non-vented mold such that when the filler/binder material assembly is subjected to pressure and subsequent infiltration, a pocket of infiltration atmosphere essentially becomes trapped within the formed composite body. This trapped atmosphere prevents complete infiltration and thus provides for the opportunity of a non-infiltrated portion of filler to be present in a formed body. Accordingly, the formed composite body may comprise a substantially flexible or compliant portion (e.g., an inner portion) and a more dense and/or more rigid portion (e.g., a skin or a shell) which design may assist in removing or harvesting the desired material from the formed composite body. However, in other cases it may be desirable to provide a means for venting some trapped pressure from a mold. For example, it may be desirable to provide a venting means at one or more specific locations within a mold to permit undesirably trapped air to be selectively released from a mold at an appropriate point during the manufacturing process. Specifically, a venting means can be provided which communicates with an external atmosphere of a mold with an internal atmosphere of the mold, the venting means being located near an upper or top of a fully compressed binder or filler material combination. Accordingly, once full compression of a binder or matrix material/filler material combination has occurred, it may be desirable to remove some of the pressure which has been built up within the combination so as to result in a more dense composite product. The venting means is discussed in greater detail later herein.

The present invention may be practiced according to the following procedures. An appropriate filler material or preform is placed or contained within a mold or barrier which may be vented or unvented. As discussed herein, resultant properties of the composite product formed can be a function of whether the mold is vented or unvented and/or whether a constriction means is provided in the mold (or contiguous to the mold). When the barrier or mold is vented, the resultant composite material is capable of being relatively dense and substantially free from porosity. When the barrier or mold is unvented, the resultant composite material is capable of having selected and desirable porosity incorporated therein. Moreover, if a constriction means is provided in the mold, or contiguous to the mold (e.g., within or near an inlet into the mold) such constriction means can favorably influence the amount of heat generated in the liquid binder or matrix material as the binder or matrix material flows into the filler. Alternatively, relatively fine porosity within a filler material or preform may, in combination with, for example, mold walls provide for sufficient constriction naturally within the molding apparatus. In this regard, the amount of heating which can result from the combination of a high pressure and a fast movement of liquid binder past, or through the porosity of the filler material (e.g., a higher surface area can result in even higher temperatures) can result in desirable infiltration of the filler material by the binder. The binder or matrix material is caused to infiltrate the filler material under the high pressure conditions of the present invention to result in desirable composite products.

The present invention is also capable of functioning with ambient air as the infiltration atmosphere. However, in certain cases, it may be desirable to utilize specific atmospheres which are different from air. For example, in order to promote and/or inhibit or prevent certain reactions within or between certain binder/matrix materials and filler materials, appropriate atmospheres can be selected. These atmospheres can be provided either locally within the filler material or preform and/or globally (e.g., essentially completely surrounding the manufacturing apparatus). Thus, specific infiltration atmospheres such as CO₂ could, for example, enhance growth rates and/or the complexity or crystal structure of various harvestable materials manufactured according to the present invention.

Conventional apparatuses or slightly modified conventional apparatuses can be used to form composite bodies according to the present invention. Specifically, for example, conventional hydraulic presses that are capable of achieving at least 200-1,000 Kp/cm² of pressure and are capable of building up to maximum pressure in about 0.5-10 seconds amount of time are acceptable. Moreover, such hydraulic presses should be capable of utilizing conventional molds or tools. Such conventional presses can be utilized in a batch or semi-continuous process. In this regard, a batch process could encompass utilizing an appropriately shaped mold or tool, placing an appropriate filler material or preform in the mold, placing an appropriate binder or matrix material in communication with at least a portion of the filler material or preform, and applying an appropriate pressure with the hydraulic press to the assembly. Pressure could then be released, the composite material removed form the mold, and the process repeated over and over. Further, the amount of time that pressure is maintained can influence, favorably, many properties of the formed composite as well as the material which is to be harvested from the formed composite. For example, the crystalline size of various portions of the formed composite (e.g., the material to be harvested) could be increased by maintaining at least some elevated pressure for a period of time beyond that required to achieve substantially complete infiltration of the binder or matrix material into the filler.

In a semi-continuous approach, a series of molds could be utilized such that similar to the batch process, the assembly would be subjected to a pressure, but then rather than immediately removing the composite material form the mold, another different mold containing another binder/filler system would be placed into the hydraulic apparatus and another composite material made, an so on.

Alternatively, a substantially continuous process for manufacturing composites of certain shapes is also possible. In this regard, techniques which could utilize somewhat conventional rollers, whereby the source of binder or matrix material can be substantially simultaneously supplied with a supply of filler material, the materials combining at a point where the rollers, which are typically rotating in opposite directions (i.e., one which rotates clockwise and the other roller rotates counter-clockwise), come into closest contact with each other. Additionally, each of the oppositely rotating rollers may have, for example, a groove provided in at least a portion thereof, whereby the supply of filler material and binder or matrix material become constricted within such groove as the rollers rotate. Alternatively, at least two annular rings could be provided upon such rollers, whereby an area between the rings, in combination with the surface of the rollers, can cause the supply of filler material and binder or matrix material to be appropriately constricted and thus achieve the dynamically forced wetting of the filler material. Further, one roller alone may have grooves or rings functioning as a constriction means, or both rollers may have such grooves or rings functioning jointly as a suitable constriction means. For example, a sheet, rod or the like, of composite product could be manufactured and portions thereof subsequently harvested. Additionally, various pull trusion methods could be utilized according to the present invention.

An important element of dynamically forced wetting is the rapid application of relatively high pressures to the assembly of filler material or preform and binder or matrix material. It is the rapid application of pressure that can result in desirable liquefaction and formation of desirable composite materials when appropriate binders or matrix materials are utilized. Moreover, it is the rapid application of pressure, in combination with a suitable constriction means, when combined with, for example, small amounts of binder relative to filler material (e.g., only a few molecules of binder are present between the distinct portions of filler) that permits or enables a rapid cooling of the binder due to the presence of a large volume percent of relatively cool filler material. This fact permits the formation of a predominant phase within a binder or matrix material that would ordinarily not be expected to be present. This aspect of this embodiment of the present invention can produce interesting products or materials in or on at least a portion of a formed composite body such materials being removable or harvestable from the formed composite body. Whether the high temperatures that result from rapid infiltration constriction causes the setting of the binder; or the competing mechanism of rapid cooling occurs, is typically a matter of degree. In particular, when a relatively large thermal mass of binder is present relative to the filler, than the setting techniques due to the high temperatures which naturally result are likely to dominate. Whereas, when a relatively small thermal mass of binder is present relative to the filler, then rapid cooling of the relatively thin layers of binder between the filler is likely to dominate even though similar high temperatures were generated in the binder during infiltration. However, it should be understood that both of these mechanisms are also a function of the available surface area of filler (i.e., the size of the filler).

For example, in a simple embodiment of the invention, when the filler comprises a mat of fibers, such mat is impregnated with an infiltrating atmosphere; (e.g., air) in its repose condition and the system as a whole is compressible and resilient. It is noted that in a typical embodiment of the present invention, if a fibrous mat (e.g., cotton fiber) is a thickness of 10×, than the same mat will typically be somewhere between 0.02-0.10× in its ultimate thickness after being compressed and infiltrated. On the other hand since the binder is a liquid and therefore is substantially non-compressible, when pressure is applied to a constricted system of fibers and binder (e.g., within a mold or tool), this pressure is substantially immediately transferred to the liquid binder which is then propelled relatively rapidly through the interstices of the mat of fibers. As the binder is being forced through the mat of fibers it may expel substantially all of the infiltrating atmosphere (e.g., air) from the mat of fibers, thereby creating a substantially anaerobic condition between the binder and the mat of fibers. The atmosphere may play a significant or insignificant role in the creation of the composite and/or the material which is to be harvested from the composite. Furthermore, as the binder is being forced past the fibers, and depending upon the particular morphology of the fibers, a frictional constrictive resistance of varying amounts can be created between the moving binder and the substantially stationary fibers; and the energy which overcomes such frictional forces can manifest itself as heat. Additionally, a suitable constriction means (e.g., a metal ring such as a circlip) may also be desirable to utilize in combination with the naturally occurring constriction means in the filler material or preform. In this regard, it may be desirable to utilize a constriction means that controls the amount of frictional energy (and thus thermal energy built-up in the system) between the binder and matrix material as it passes around, in, over, through, and/or within, etc., the constriction means. The created frictional heat, may reduce the viscosity of an appropriately chosen binder or matrix material which may render the binder capable of penetrating smaller and smaller voids or porosity in the fiber mat; which can lead to even greater flow resistance; which in turn can result in more frictional forces and even higher temperatures. The presence of a suitable amount of constriction (e.g., in addition to the amount of constriction that inherently occurs due to the processing parameters) can be controlled to result in desirable amounts of energy (e.g., thermal energy being transferred to the infiltrating binder or matrix material). These higher temperatures, may result in an even more rapid hardening of the binder/matrix material when the binder/matrix material comprises a material which hardens (or the hardening is at least accelerated) with increased temperatures.

In this regard, in a desirable embodiment of the invention, a binder is, or can be made to be, in a “cure-critical state” substantially at the same moment that infiltration begins. For example, many conventionally available polymers can be activated by a catalyst. It may be desirable in certain methods of practicing the invention, to utilize a binder that includes a catalyst that has already been mixed with a polymer and may just begin to be setting prior to injecting it under pressure into the filler. Accordingly, resultant properties of a formed composite can be engineered by operating at or near a cure-critical state of a binder or by operating under conditions which are not near a cure-critical state of a binder. However, when operating under conditions that are not near the cure-critical state of a binder, a dwell time of the filler/binder mixture in a mold can be expected to be larger than a binder which infiltrates at or near its cure-critical state.

Moreover, in this process, as the binder passes over the surface of the fibers or filer material, another important event may occur. As the binder passes by the fibers at a relatively high rate of speed (e.g., a speed which typically exceeds the crosshead speed of a hydraulic press by a factor of 1.5-500 times as fast due to the geometry of the filler) and at a relatively high pressure, then the binder may abrade and/or clean at least a portion of the surface of the fibers. For example, any loose debris, as well as any macro-contaminants, can be removed from one or more surfaces of the fiber, thereby creating more ideal bonding conditions for the filler/binder interface.

Moreover, in addition to cleaning loose debris (e.g., macro-contaminants), in certain embodiments of the invention certain micro-contaminants may also be removed from at least a portion of a surface of a filler material. In these cases, the heated and rapidly moving binder or matrix material may dislodge chemically bonded materials such as gas molecules and enable or permit desirable free radical bonding at one or more surfaces of a filler material particle or fiber. Such bonding leads to, for example, enhanced strength of a composite material, as well as a host of other desirable properties.

Still further, certain filler materials may be provided such that as the binder contacts or approaches the filler, the pressure that is created in the system could cause the filler to break, fracture, fragment and/or substantially disintegrate, which itself may result in a release of energy from the filler material (e.g., a release in the form of heat). Further, any material(s) included in the filler material (e.g., gasses or other materials) could also then be released and take part in the formation of a desirable composite and/or a desirable material which is harvestable from the formed composite.

In addition, the liquid binder may also act as a lubricant allowing for increased mobility between the fibers, which in turn may permit a greater packing order for the fibers. For example, in the present invention, the lubricant (liquid binder) can be caused to penetrate the mat of fibers substantially immediately before compaction of the fibers takes place. At the same time and almost paradoxically, it is known from the literature (Nature—Vol. 347—Sep. 20, 1990 pp 227-228) that when liquids are reduced to monomolecular thicknesses between solid surfaces they behave like solids. It is this characteristic of liquids, combined with the frictional heat generated between the filler and the binder, which in turn can accelerate chemical reactions within the system that can give rise to the substantially spontaneous curing of the binder or matrix material within the formed composite material. Even if monomolecular thicknesses are not always achieved, again dependent on fiber morphology and juxtaposition of fibers, it is possible that even several molecular thicknesses are sufficient to give rise to instant solidification either because the thermal mass of the relatively thin binder is lower than that of the surrounding fibers or because of the increased aggression (e.g., given smaller mass and greater heat of the binder) of any catalyst promoting polymerization or solidification of the binder.

### DETAILED DESCRIPTION OF THE INVENTION

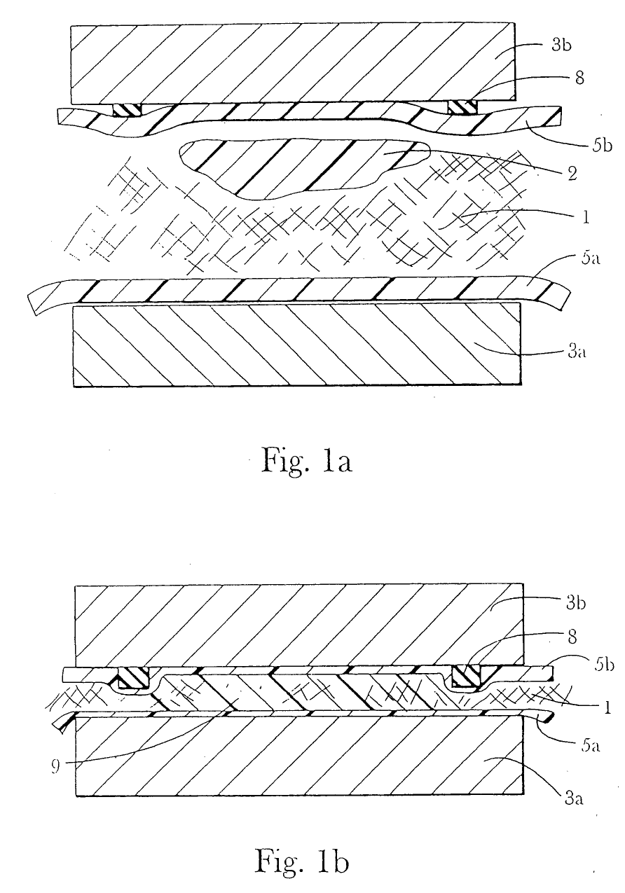

FIG. 1a shows a representative lay-up for manufacturing composites according to the present invention. Specifically, FIG. 1a is a general, cross-sectional schematic view of a simple lay-up which contains certain basic elements used in one embodiment for forming composites according to the techniques of the present invention. Specifically, a filler material or preform 1 is placed onto (e.g., if a mold comprises a substantially planar surface) and/or into (e.g., if a mold comprises a cavity) a female portion 3a of a mold or tool. A thin sheet of mold release material 5a (e.g., polyethylene or any other suitable material) can be placed between the female portion 3a of the mold and the filler material or preform 1. Alternatively, suitable mold release compounds can be coated directly upon the female portion 3a of the mold. Such mold release compounds are conventional and well known in the art and include low molecular weight PTFE, spray-on mold release coatings, etc. The mold release material or sheet 5a is used to expedite the removal of a formed composite from the female portion 3a of the mold. However, certain more exotic, but simple and inexpensively applied coatings could also be used. For example, those techniques disclosed in U.S. Pat. No. 5,368,890, the entire subject matter of which is incorporated herein by reference, could also be used. In this regard, materials such as PTFE, SILICONE and diamond film could all be applied by the techniques of the aforementioned patent.

An appropriate amount of binder or matrix material 2 can then be placed onto (e.g., the binder or matrix material 2 does not substantially wet and/or is not given an opportunity to substantially wet the filler material 1) and/or into (e.g., the binder or matrix material 2 naturally wets or can be made to wet at least a portion of the filler material or preform 1) at least a portion of the filler material or preform 1. The binder or matrix material 2 can be any suitable material which is capable of infiltrating the filler material or preform 1 under the process conditions of the present invention and which, when hardened or set, provides for desirable properties in a formed composite body. Another layer or sheet of mold release compound 5b can be placed on top of the assembly of filler material or preform 1 and binder 2 to assist in releasing the formed composite from a male portion 3b of the mold. A traditional mold release material can also be used in the male portion 3b of the mold rather than a sheet of material 5b. The male portion 3b of the mold can be of any desired size and/or shape, including, in this simple view, a relatively planar surface. However, typically, when the male or female portions of a mold are joined, the composite is shaped therebetween. Moreover, it may be desirable to include a constriction means 8 (in this FIG. 1a the constriction means is shown as an annulus on the male portion 3b of the mold) to assist in desirably constricting the flow of binder 2 into the filer material or preform 1. In this regard, the constriction mean 8 can be of a sufficient size and shape that it only needs to be provided in the male portion 3b of the mold. However, in an alternative embodiment of the present invention, a similar or complementary constriction means could also be provided on the female portion 3a of the mold. This would simply be a matter of engineering design choice and would be apparent to one of ordinary skill in the art. Accordingly, a composite product made according to the embodiment shown in FIG. 1a, will be substantially flat and be of a sheet-like or block-like-nature, depending on the amount of filler and binder used. In this regard, a composite product 9 made according to the embodiment shown in FIG. 1a is shown in FIG. 1b. Specifically, infiltration of the binder of matrix material 2 has occurred into the filler material or preform 1 substantially within the confines the constriction means 8.

The male 3b and female 3a portions of the mold should be moveable, one relative to the other, such that they can open and close. It is not critical whether the male portion 3b moves or the female portion 3a moves, however, sufficient pressure of about 20-10,000 Kp/cm² is desired, about 100-1,000 Kp/cm² is even more desirable and about 250-1,000 Kp/cm² is the most desirable. These pressures should be able to be achieved within a relatively short amount of time (e.g., less than a second to a few seconds). It is most desirable to achieve operating pressures in about 30 seconds, even more desirable within about 15 seconds and most desirable in about 5 seconds or less. Without wishing to be bound by any-particular theory or explanation, processing pressures and processing times (i.e., the time required to achieve maximum pressure and the amount of time that maximum pressure is held) appear to be inversely related to each other.

For example, the shorter the amount of time that infiltration takes place, the shorter the dwell time in the mold under pressure. Examples include about one (1) second of infiltration and about one (1) second dwell time versus about thirty (30) seconds of infiltration time and about five (5) minutes of dwell time. The inverse relationship between infiltration time and dwell time is present in many binder materials. Further, without wishing to be bound by any particular theory or explanation, even though rapid infiltration under relatively high constrictive pressures typically results in high temperatures in the binder material, if a relatively small thermal mass of binder material is present relative to a large thermal mass of filler material, then the phases which occur in the binder material could be non-traditional phases. In this regard, for example, it is known that PTFE (polytetrafluoroethylene) is a relatively highly crystalline polymer that has a regular folded structure. The crystallinity of this polymer has been estimated by various x-ray techniques and density measurements. It has been noted, however, that rapidly cooled samples of PTFE have lower crystallinity than slower cooled samples. However, the crystallinity of this material is typically in the range of 50-90%. By practicing the dynamically forced wetting of a filler material, it is possible to achieve relatively small amounts of binder material relative to the filler material and then achieve very rapid cooling of the binder. This rapid cooling can change a crystalline binder into one which is non-crystalline or amorphous. This phenomenon is unique to the present invention because prior art techniques do not permit composites to be formed by using such small amounts of binder material while still wetting the filler rapidly. Similarly, traditionally amorphous materials may become crystalline. In this regard, materials which typically comport to an amorphous structure can be caused to adopt a crystalline structure due to the aforementioned infiltration followed by rapid cooling phenomenon. This particular aspect of the invention can result in very unique composite products which may include harvestable portions which comprise desirable materials.

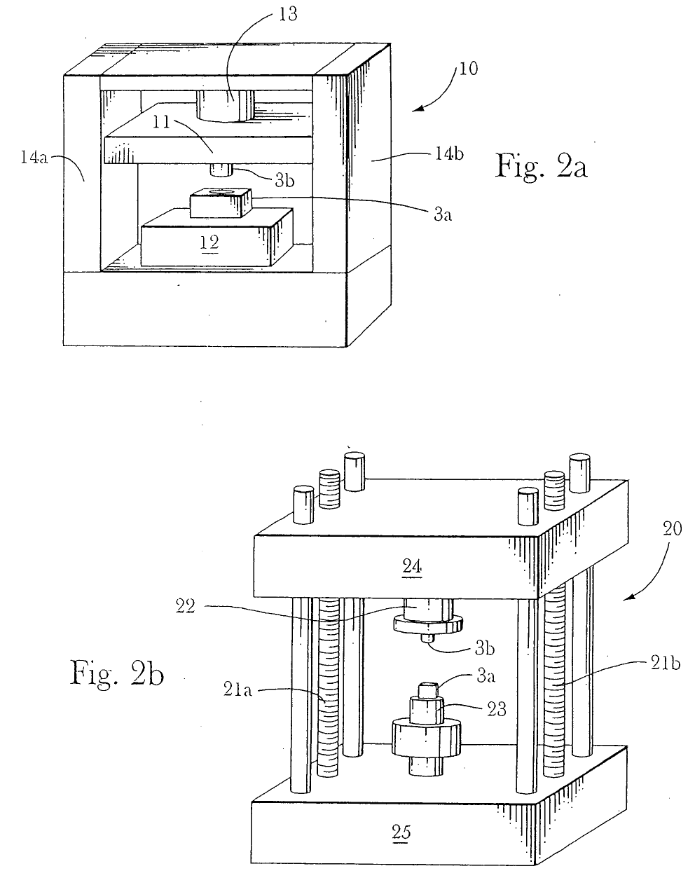

FIG. 2a shows a first industrial press 10 which is capable of being utilized in practicing the techniques of the present invention. The press 10 comprises a stable base portion 12 upon which a female portion 3a of a mold can be placed. An upper portion of the press 11 is capable of moving vertically within the siderails 14a, 14b because the uppermost portion 11 is driven by a hydraulic piston 13 which is capable of moving vertically within the siderails 14a, 14b. A male portion 3b of the tool is mounted on an upper portion 11 of press 10. Accordingly, a suitable filler material or preform can be placed on and/or within the female portion 3a of the mold. An appropriate binder or matrix material can then be brought into contact with the filler material or preform and the male portion 3b of the tool can then be brought into contact with the filler material/binder mixture and the male portion 3b of the tool can be utilized to force the binder material into the filler material or preform. After an appropriate amount of pressure has been achieved (e.g., 200-1,000 Kp/cm²) in an appropriate amount of time (e.g., 0.5-5 seconds) and has dwelled with such pressure for a substantial amount of time (e.g., 1 second-2 minutes) the hydraulic cylinder 13 retracts the male portion 3b of the tool from the female portion 3a of the tool and due to the processes of the invention as described herein, a formed composite material can then be removed from the female portion 3a of the tool.

FIG. 2b shows another industrial press 20 which can be utilized in accordance with the techniques of the present invention. This industrial press 20 is similar to the industrial press 10 shown in FIG. 2a, except that a primary difference is that an electric raising and lowering mechanism for moving male or female portions of a die is also provided in addition to a hydraulic mechanism, which mechanism is similar to that of FIG. 1a.

Specifically, the press 20 comprises two screw jacks 21a and 21b which are capable of rapidly raising and lowering the top stage 24 relative to the bottom stage 25. In addition, a hydraulic lift cylinder 23 is also provided on the bottom stage 25. In the press 20, a female portion 3a of the tool can be placed upon the hydraulic cylinder 23, and a male portion 3b of the tool can be contacted with the portion 22 which extends from the top stage 24. An appropriate filler material or preform can be placed onto and/or within the female portion 3a of the tool and an appropriate binder or matrix material can be placed into contact therewith. The screw jacks 21a and 21b can then be activated and cause the top stage 24 to approach the bottom stage 25, thus resulting in the assembly (i.e., the male 3b and female 3a portions of the tool) to be in near contact with each other. Once such near contact is achieved (e.g., when the male 3b portion of the tool contacts at least a portion of the filler and/or the mold release material) the hydraulic cylinder 23 can be actuated to achieve appropriate processing pressures (e.g., 200-1,000 Kp/cm²) in an appropriate amount of time (e.g., 0.5-10 seconds). After holding the male 3b and female 3a portions together for the required amount of time (e.g., 1 second-2 minutes) the portions of the tool 3a, 3b are then separated from each other by first removing the hydraulic pressure by retracting the hydraulic cylinder 23 and then thereafter engaging the screw jacks 21a and 21b in a reverse manner.

In each of the hydraulic presses 10 and 20 shown in FIGS. 2a and 2b, respectively, it can be envisioned that these presses can be utilized in a batch process or a semi-continuous process. In particular, with regard to a semi-continuous process, a line of tools could be positioned such that so soon as one composite had been formed in a first tool, that tool could be removed from the press and replaced with a second tool, and so on.

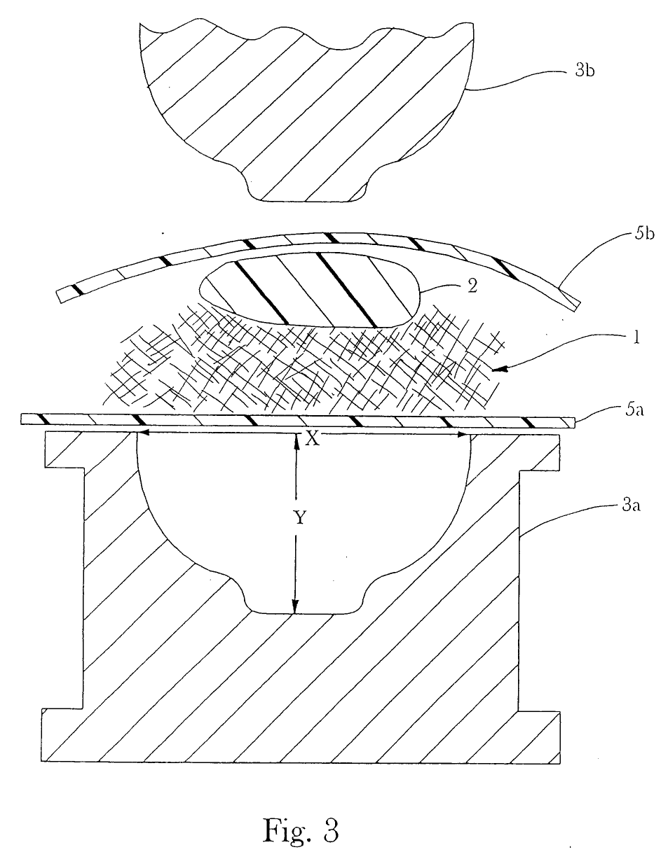

FIG. 3 shows a cross-sectional schematic view of an actual lay-up utilized to form a complex-shaped composite by a batch process according to the present invention. This lay-up could be placed in either of the hydraulic presses 10 or 20. In this Figure, the female portion 3a of the mold, when combined with the male portion 3b of the mold, form a shape which comprises a reflector light bulb. The diameter “x” of the light bulb cover is about 122.5 millimeters and the total depth “y” of the light bulb cover is about 61 millimeters. In this embodiment, a mold release element 5a comprises a thin sheet of polyethylene foil. The thin sheet of polyethylene foil 5a measured about 0.1 millimeters in thickness and was about 250 millimeters by 250 millimeters in total area. The polyethylene sheet was manufactured by TVK-Rt and is a typical material utilized in the shipping industry. Acceptable sheet thicknesses for the polyethylene material are about 0.025 millimeters to about 0.25 millimeters. The polyethylene sheet was provided as a simple assistant for removing a formed composite from the female portion 3a of the die, however, any suitable mold release could work.

A dry mat of cotton fibers 1 was then placed upon the polyethylene sheet 5a. In this regard, the dry sheet of cotton fibers 1 actually partially filled the female portion of the die 3a and a portion of the fibers stuck out from the die 3a. These fibers come from a commercially available, non-sterile, 100 percent pure, roll of cotton wool. Particularly, the fibers come as a wrapped “log” or roll which has a width of about 12 inches and was about 15 feet long. Sheets of this cotton wool were cut into about 12 inch×12 inch sections and stacked on top of each other until a height of about 12 inches was obtained. Thus, the stack of substantially pure cotton fibers measured about 12″×12″×12″. The choice of cotton fibers was made because of their cost (e.g., relatively inexpensive) and availability (i.e., essentially available all over the world) and of substantially constant properties that can be achieved, independent of source, that can result in desirable and relatively consistent composite properties in products formed.

After the dry mat of fibers 1 was positioned on and within the female portion 3a of the die, a cyanoacrolate binder 2 was poured from a container onto a center portion of the mat of fibers 1, such that the cyanoacrolate binder 2 was substantially centered upon the fibers 1. This cyanoacrolate binder 2 was manufactured by Chemence Company and goes by the name of Rite-Lok EC5. The amount of cyanoacrolate binder 2 used was about a 50 grams. It may be noted that it is not necessary for the binder 2 to substantially, naturally wet the dry mat of fibers 1, to any significant degree when the binder 2 was placed into initial contact with the fibers 1. Once the binder 2 had been placed in contact with the fibers 1, another sheet of polyethylene foil 5b was placed on top of the assembly. The second sheet of polyethylene foil 5b was provided to assist in separating the male portion 3b of the die from the formed composite.

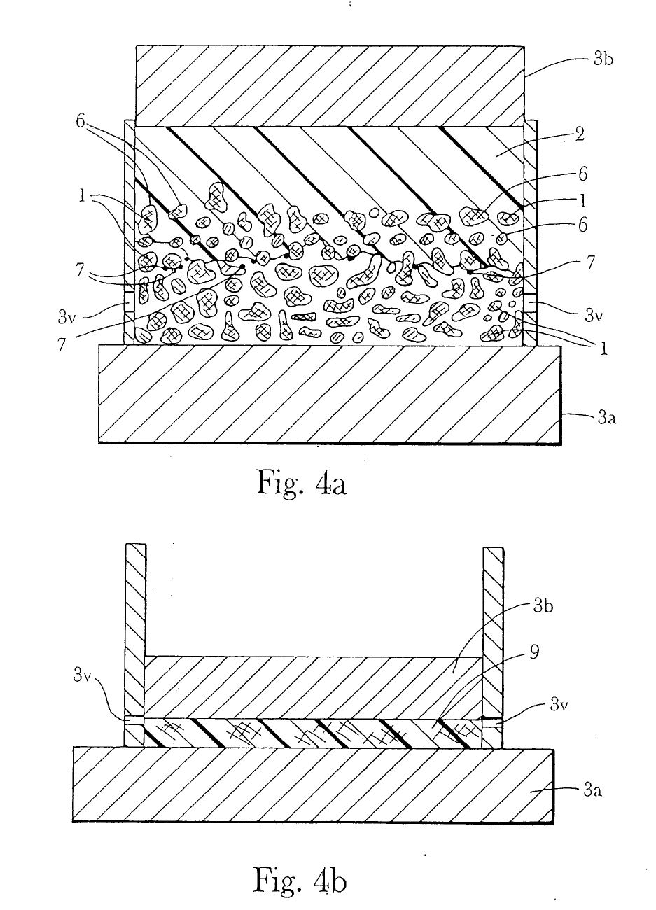

The male portion 3b of the die was then caused to come into contact with the sheet of polyethylene foil 5b and the pool of binder 2 and the mat of fibers 1 within the female portion 3a of the die. Upon initial contact of the male portion 3b of the die with the sheet of polyethylene foil 5b, the binder 2, the filler 1 and the female portion 3a of the die, a force of about 250 Kp/cm² was exerted in about five (5) seconds. The importance of the applied pressure, as well as the rate at which the applied pressure was applied is important because these factors, when combined with mold design, resulted in desirable constrictive flow within the fibers 1. This important feature is discussed again in detail with regard to FIG. 4, herein.

After the female 3a and male 3b portions of the die were caused to be together under a load of about 250 Kp/cm² for about 20 seconds, the male portion 3b of the die was then removed from the female portion 3a of the die and a composite in the female portion 3a of the die was formed. In this regard, the composite had a wall thickness of about 3/8 inch (9 mm) and had a density of about 1.25 grams/cm³.

FIG. 4a shows a cross-sectional view of a partially infiltrated composite made according to the processes discussed above. This partially infiltrated view is helpful to understand the mechanisms of the present invention.

In this embodiment the application of pressure has just begun such that the pool of binder 2 has begun to rapidly infiltrate the filler material 1. This particular filler material 1 comprises a mixture of randomly oriented fibers and particulate. The binder 2 begins to infiltrate the filler 1 at a relatively high rate of speed (e.g., the crosshead speed was about six inches/second and the infiltration rate was a multiple of that speed) and under pressures of at least that which is applied to the binder 2, namely, somewhere between 250-500 Kp/cm². The relatively rapid movement of the binder 2 through the interstices or mat of fibers or filler 1 results in a frictional heat being generated at least at the portions 6 where the pool of binder is contacting the filler material and the filler material, in conjunction with the side walls of the die, function as the constriction means. In particular, without wishing to be bound by any particular theory or explanation, when pressure is applied to the system of fibers 1 and binder 2 (e.g., within a mold or tool), this pressure is substantially immediately transferred to the liquid binder 2 which is then propelled relatively rapidly through the interstices of the mat of fibers 1. As the binder 2 is being forced through the mat of fibers 1 it may expel substantially all of the infiltrating atmosphere (in this Example the infiltrating atmosphere is air) from the mat of fibers 1 through the vented sidewalls 3v, thereby creating a substantially anaerobic condition between the binder 2 and the mat of fibers 1. Furthermore, as the binder 2 is forced past the fibers 1, a frictional resistance due to constriction is created between the moving binder 2 and the substantially stationary fibers 1 at portions 6 through the mat of fibers 1 and the energy which overcomes such frictional forces manifests itself as heat. The created frictional heat reduces the viscosity of the binder 2 which renders the binder capable of penetrating smaller and smaller voids or porosity in the fiber mat 1 (and even within particles which may themselves contain porosity) which leads to even greater flow resistance which in turn results in more frictional forces and even higher temperatures. Moreover, as discussed elsewhere herein, as the binder 2 passes over the surface of the fibers 1, another important event occurs. The binder actually abrades and/or cleans (both at a macro-contaminant and micro-contaminant level) at least a portion of the surface of the fibers 1. For example, any loose debris 7, as well as any contaminants 7, can be removed from one or more surfaces of the fiber 1, thereby creating more ideal bonding conditions for the filler/binder interface.

In addition, as discussed elsewhere herein, the binder 2 may also act as a lubricant allowing for increased mobility between the fibers 1, which in turn may permit a greater packing order for the fibers 1. For example, in the present invention, binder 2 penetrates the mat of fibers 1 substantially immediately before compaction of the fibers takes place. At the same time and almost paradoxically, it is known from the literature. (Nature—Vol. 347—Sep. 20, 1990 pp 227-228) that when liquids are reduced to monomolecular thicknesses between solid surfaces they behave like solids. It is this characteristic of liquids, combined with the frictional heat generated between the fillers 1 and the binder 2, due to constriction which in turn can accelerate chemical reactions within the system that can give rise to, for example, the substantially spontaneous curing of the binder 2 within the formed composite material, different phases being present within the binder 2, etc. Even if monomolecular thicknesses are not always achieved, again dependent on fiber morphology and juxtaposition of fibers, it is possible that even several molecular thicknesses are sufficient to give rise to instant solidification either because the thermal mass of the relatively thin binder is lower than that of the surrounding fibers or because of the increased aggression (e.g., given smaller mass and greater heat of the binder) of any catalyst promoting polymerization or solidification of the binder.

FIG. 4b shows a desirable location of the vent holes 3v within the side of the tool. In this regard, it is desirable for the height of the venting holes 3v to correspond substantially to a final height of the ultimately compressed composite product (i.e., the combination of filler material 1 with binder 2. This particular configuration permits an outgassing of trapped gases but also permits the generation of relatively high pressures within the system.

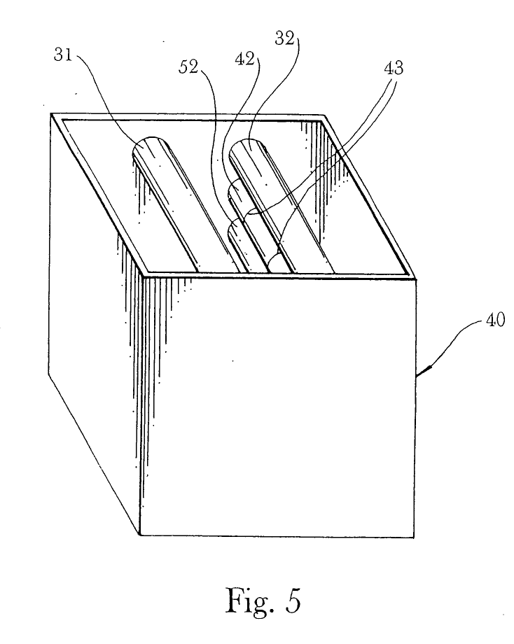

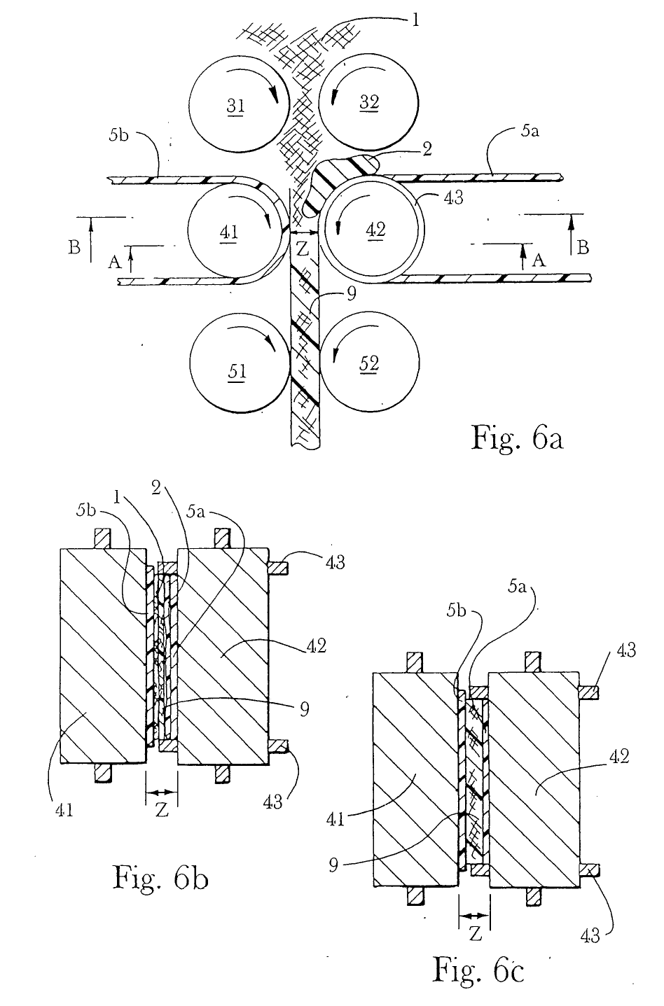

FIG. 5 shows a perspective view of the top of a simple roller apparatus 40 that can be used for fabricating composites by a substantially continuous process. In reference to FIGS. 5 and 6a-6c, a simple apparatus 40 is comprised of, for example, multiple pairs of axially aligned rollers. The roller pairs 31, 32; 41, 42; and 51, 52 are fixed relative to each other such that a predefined distance or gap is set therebetween. The predefined distance or gap between each pair of rollers, but especially the gap between the pair 41, 42, will correspond approximately to the thickness of the composite formed as the composite is run through the roller assembly 40. The assembly 40 can be any simple apparatus (e.g., as simple as a pasta making machine) or a very complex apparatus currently used to form composite materials. Additionally, a constriction means 43 can be desirably placed upon the rollers 41 and 42. In this particular embodiment of the present invention, the constriction means 43 comprises a pair of rings or annuluses located on the roller 42. Alternatively, a groove can be created within the roller 42 and substantially similar constriction effects can be achieved. Alternatively, rings or grooves could be provided on both rollers 41 and 42. The choice is a matter of design preference.

FIGS. 6a, 6b and 6c show various views of a 3-pair roller assembly utilized in one example of a continuous process for making composite product according to the dynamically forced wetting techniques of the present invention.

Specifically, FIG. 6a shows a schematic cross-sectional view of a representative continuous process for the formation of composites according to the present invention. A first set of rollers 31 and 32 partially compresses the filler 1 and feeds the partially compressed filler into the rollers 41 and 42. In this regard, rollers 41 and 42 are positioned apart from each other at a predetermined distance “z” (i.e., the distance between the closest portions of the rollers relative to each other is “z”). The rollers 41 and 42, just like rollers 31 and 32, are caused to rotate in opposing directions such that roller 41 is rotating clockwise and roller 42 is rotating counterclockwise. Each of the rollers 41 and 42 may be driven or one may be driven and the other roller be a slave. A constriction means 8 in the form of two rings 43, axially separated on the roller 42, are provided only on the roller 42. In this embodiment of the present invention, a source of filler material 1 and binder 2 can be provided substantially contiguously on an input side of the rollers 41 and 42. A finished composite 9 is produced out of the output side of the rollers 41 and 42, but undergoes additional contact with the rollers 51 and 52, which are also rotating in the same direction as the rollers 31, 32 and 41, 42. The amount of binder or matrix material provided relative to the amount of filler provided can be adjusted so that composites having varying properties can be formed.

FIG. 6b is a cross-sectional view taken along the line B-B′ in FIG. 6a. In particular, the rollers 41 and 42 are separated by a distance Z. The roller 41 has a sheet of polyethylene 5b that rotates at substantially the same speed as the roller 41. Likewise, the roller 42 has a sheet of polyethylene 5a that also rotates at the same speed as the roller 42. The roller 42 creates a constriction means by use of the two annular rings 43. In particular, the annular rings 43 extend outward from an outer radial surface of the roller 42 and toward the roller 41. As the filler 1 and binder 2 come into contact with each other within the space Z between the rollers 41 and 42 and within the constrictive space defined by the two rings 43, high pressure is developed. The portion 9, shows a portion of the filler material infiltrated with binder 2 forming a beginning of composite material 9.

FIG. 6c is similar to FIG. 6b, except that its corresponding cross-section is taken along the lines A-A′ of FIG. 6a. Accordingly, the filler material 1 has been completely infiltrated by the binder 2 thus forming a fully formed composite 9 within the space Z formed between the surfaces of the two (2) rollers 41 and 42, and within the confines of the two annular rings 43.

### EXAMPLES

### Example 1

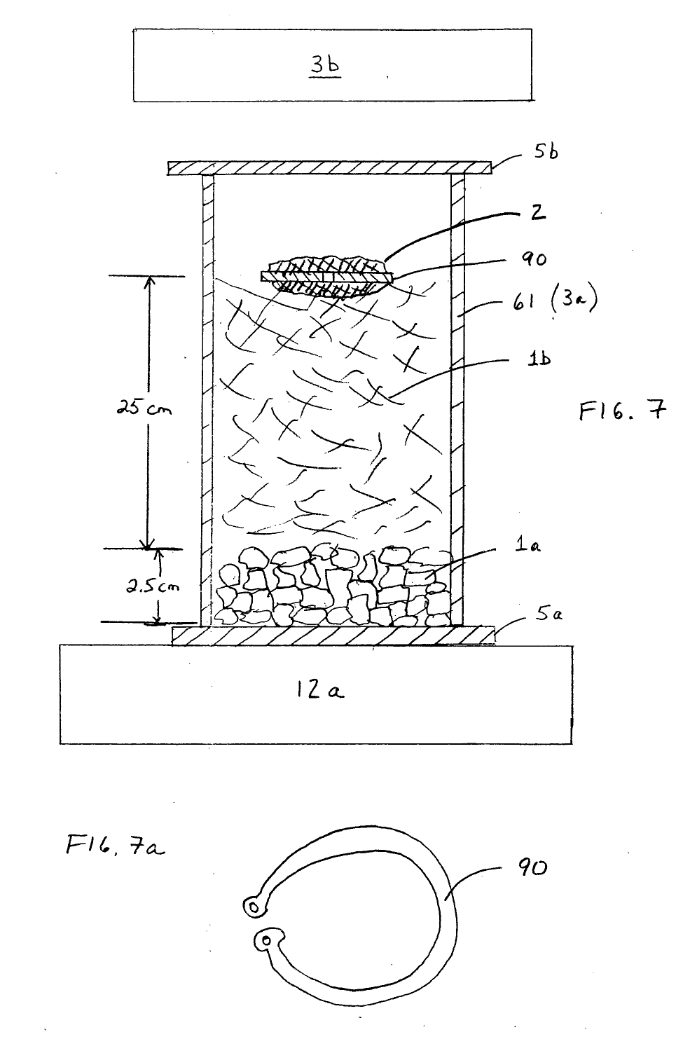

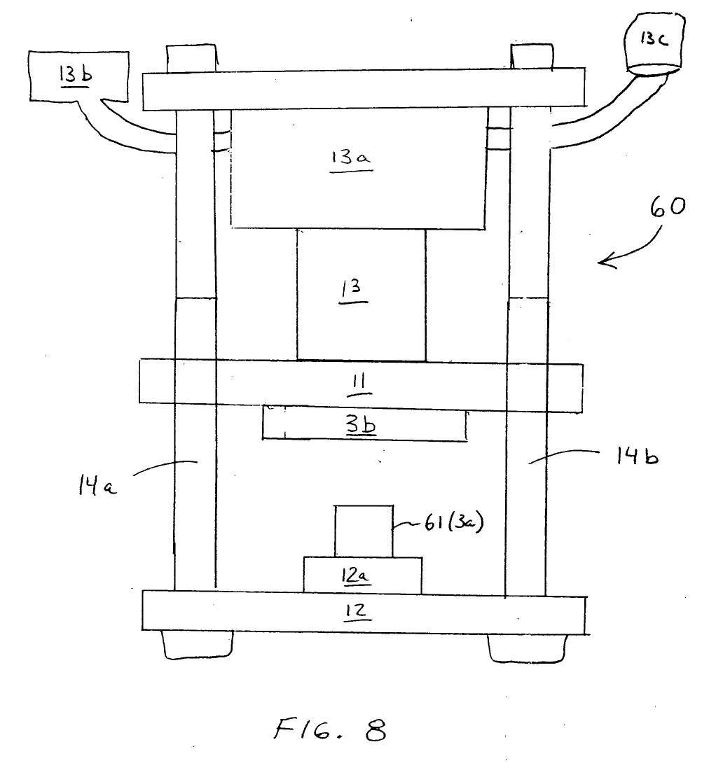

FIG. 7 shows a cross-sectional view of an actual lay-up utilized to form a composite by a batch process according to the present invention. In particular, this lay-up results in the formation of a harvestable material in at least a portion of the formed composite. In this regard; the harvestable material comprises diamond which is present on at least a portion of a surface of the formed composite. Specifically, FIG. 7 shows a cross-sectional schematic view of an actual lay-up utilized to form a composite by a batch process according to the present invention. This lay-up could be placed in either of the hydraulic presses 10 or 20, but was actually placed in the press 60 shown in FIG. 8. In this embodiment, mold release elements 5a, 5b comprise a thin sheet of polyethylene film. The thin sheet of polyethylene film 5a, 5b measured about 0.1 millimeters in thickness and more than covered the top and bottom areas of the tube 61, respectively. The tube 61 was also made from polyethylene film. The polyethylene film was manufactured by TVK-Rt and is a typical material utilized in the shipping industry. Acceptable sheet thicknesses for the polyethylene material are about 0.025 millimeters to about 0.25 millimeters. The polyethylene sheets 5a, 5b were provided as a simple assistant for removing a formed composite from the male portion 3b of the die and the base plate 12, however, any suitable mold release material should work. However, the polyethylene sheet that formed the tube 61, actually functioned as the initial female portion 3a of similar dies discussed elsewhere herein. However, the tube 61 is substantially completely deformed by the pressure exerted by the male portion 3b against the base plate 12 of the press 60 and thus the female portion 3a is destroyed in the composite formation process.

Marble granules 1a were then placed upon the polyethylene sheet 5a. In this regard, the marble granules were actually marble chips from a typical marble cutting operation. These marble chips are capable of being used to form a material known as, for example, Torazo, which is used to manufacture commercial flooring. The marble granules 1a were loosely filled into the bottom of the tube 6 to a height of about 2.5 cm in the tube 61. A layer of wood shavings, 1b was then loosely stacked on top of the marble granules to a depth of about 25 cm. A constriction means 90 comprising an item known as a “circlip” (e.g., a Seeger-ring used to seal shafts) was positioned approximately in the center of the tube 61 on top of the wood shavings 1b. A perspective view of the circlip 90 is shown in FIG. 7a.

After the filler materials 1a, 1b were positioned within the tube 61 and the constriction means 90 was centered thereon, a cyanoacrolate binder 2 was poured from a container onto a center portion of the mat of filler 1b such that a cyanoacrolate binder 2 was substantially located within the diameter of the circlip 90. This cyanoacrolate binder 2 was manufactured by Chemence Company and goes by the name of Rite-Lok EC5. The amount of cyanoacrolate binder 2 used is a function of choice. Moreover, it should be noted that it is not necessary for the binder 2 to substantially, naturally wet the filler 1a, 1b to any significant degree when the binder 2 was placed into initial contact with the filler 1b. Once the binder 2 had been placed in contact with the filler 1b, another sheet of polyethylene film 5b was placed on top of the assembly. The second sheet of polyethylene film 5b was provided to assist in separating the male portion 3b of the die from the formed composite.

The male portion 3b of the die was then caused to come into contact with the sheet of polyethylene film 5b and the pool of binder 2 and the filler 1a, 1b within the tube 61. Upon initial contact of the male portion 3b of the die with the sheet of polyethylene film 5b, the binder 2, the filler 1a, 1b and the female portion 3a of the die, a force of about 250 Kp/cm² was extended in about five (5) seconds. The importance of the applied pressure, as well as the rate at which the applied pressure was applied, is important because these factors, when combined with the constriction means 90, resulted in desirable constrictive flow within the filler 1a, 1b. This important feature was discussed in detail with regard to FIG. 4 herein.

After the tube 61 (in contact with base plate 12) and male 3b portion of the die were caused to be together under a load of about 250 Kkp/cm² for about 20 seconds, the male portion 3b of the die was then removed from the base plate 12 and a composite was formed within the area defined by the constriction means 90. Moreover, portions of the formed composite contained crystals that had a composition and structure corresponding to diamond.

FIG. 8 shows another industrial press 60 which is capable of being utilized in practicing the techniques of the present invention. The press 60 comprises a stable base portion 12, 12a upon which a female portion 3a of a mold, or the tube 61 of FIG. 7, can be placed. An upper portion of the press 11 is capable of moving vertically within the siderails 14a, 14b because the uppermost portion 11 is driven by a hydraulic piston 13 which is capable of moving vertically within the siderails 14a, 14b. The hydraulic piston 13 is driven by the hydraulic cylinder 13a. Additionally, oil reservoir 13b and pressure storage reservoir 13c assist in driving the hydraulic piston 13. A male portion 3b of the tool is mounted on an upper portion 11 of press 10. Accordingly, a suitable filler material or preform can be placed on and/or within the female portion 3a of the mold (or within the tube 61). An appropriate binder or matrix material can then be brought into contact with the filler material or preform and the male portion 3b of the tool can then be brought into contact with the filler material/binder mixture and the male portion 3b of the tool can be utilized to force the binder material into the filler material or preform. After an appropriate amount of pressure has been achieved (e.g., 200-1,000 Kp/cm²) in an appropriate amount of time (e.g., 0.5-5 seconds) and has dwelled with such pressure for a substantial amount of time (e.g., 1 second-2 minutes) the hydraulic cylinder 13 retracts the male portion 3b of the tool from the base portion 12, 12a and due to the processes of the invention as described herein, a formed composite material with a harvestable material comprising diamond is produced.

### Example 2

This Example shows that a layered composite can be manufactured comprising at least three components: a filler comprising cotton fiber, aluminum powder and a cyanoacrylate binder.

A lay-up, substantially corresponding to that lay-up shown in FIG. 1, was utilized in a press substantially corresponding to the press shown in FIG. 2a. A primary difference of this particular lay-up was that a layer of aluminum powder was first placed upon a sheet of polyethylene 5a, which was placed on mold 3a. Cotton fibers were then placed upon the aluminum powder; additional aluminum powder, cotton fibers and aluminum powder were thereafter sequentially laid on top. A cyanoacrylate binder was then placed into contact with the top layer of aluminum powder. The polyethylene sheet 5b was then placed on top of the entire assembly. Thus the assembly, from bottom to top comprised mold 3a, aluminum powder, cotton fibers, aluminum powder, cotton fibers, aluminum powder, cyanoacrylate binder, sheet 5b and mold 3b. This lay-up resulted in a composite having various layers or striations to be formed.

Specifically, the lay-up was rapidly pressed up to a maximum pressure of about 250 Kp/cm² in about five seconds. The lay-up was held under this pressure for about five seconds and then the pressure was released.

### Example 3

A lay-up substantially corresponding to that lay-up shown in FIG. 1, was utilized in a press substantially corresponding to the press shown in 2a. In this embodiment, steel wool fibers 1 and a cyanoacrylate binder 2 were utilized. In this example, the lay-up was rapidly pressed to a maximum pressure of about 30 Kp/cm² in about 20 seconds. The lay-up was held under this pressure for about 120 seconds and then the pressure was released.

While there has been illustrated and described what is at present considered to be the preferred embodiments of the present invention, it will be understood by those skilled in the art that various changes and modifications may be made, and equivalents may be substituted for elements thereof without departing from the true scope of the invention. In addition, many modifications may be made to adapt the teachings of the invention to a particular situation without departing from the central scope of the invention. Therefore, it is intended that this invention not be limited to the particular embodiments disclosed as the best mode contemplated for carrying out this invention, but that the invention will include all embodiments falling within the scope of the appended claims.

1. A method for forming a composite comprising:
providing at least one filler material;
contacting said at least one filler material with at least one binder, wherein said at least one binder is capable of liquefaction under the process conditions of the method;
forcing said at least one binder to infiltrate into at least a portion of said at least one filler material such that frictional heat is created between at least a portion of said at least one binder and said at least one filler, said frictional heat: (1) causing said binder to be more fluid relative to said binder not experiencing said frictional heat; and (2) assisting in accelerating a setting of said at least one binder; and
holding said infiltrated filler under pressure until said at least one binder sets within said infiltrated filler.

2. A method for forming a composite and harvesting at least a portion of the formed composite comprising:
providing at least one filler;
contacting at least one binder with said at least one filler;
pressurizing said at least one binder such that said binder first experiences cold flow and subsequently is capable of liquefaction, said liquefaction occurring due to said pressing and frictional resistance experienced between said at least one binder and said at least one filler;
permitting said at least one binder to at least partially infiltrate said at least one filler such that a composite body is formed; and
harvesting at least a portion of the formed composite.

3. The method of claim 1, wherein said filler comprises at least one member selected from the group consisting of particles, fibers and whiskers, said at least one member having at least some contaminants on at least a portion of the surface thereof.

4. The method of claim 3, wherein said frictional heat that is created assists in cleaning said at least some contaminants from said filler.

5. The method of claim 2, wherein said filler comprises at least one member selected from the group consisting of particles, fibers and whiskers, said at least one member having at least some contaminants on at least a portion of the surface thereof.

6. The method of claim 5, wherein said frictional heat that is created assists in cleaning said at least some contaminants from said filler.

7. The method of claim 1, wherein said forming comprises utilizing a constriction means for forcing said binder into said filler.

8. The method of claim 2, wherein said pressurizing comprises utilizing a constriction means for constricting the flow of said at least one binder.

9. The method of claim 2, wherein said harvesting comprises removing at least a portion of said composite comprising at least one product selected from the group consisting of diamond and cubic boron nitride.

10. The method of claim 2, wherein said harvesting comprises at least one technique selected from the group consisting of etching, leaching, sandblasting and physical separation.
